(19) United States
(12) Patent Application Publication
(10) Pub. No.: US 2017/0061818 A1
(43) Pub. Date: Mar. 2, 2017

(54) SKILL TEACHING VERIFICATION SYSTEM AND SKILL TEACHING VERIFICATION PROGRAM

(71) Applicant: Renesas Electronics Corporation, Tokyo (JP)

(72) Inventors: Kenichiro HIJIOKA, Tokyo (JP); Koichi NOSE, Tokyo (JP)

(73) Assignee: Renesas Electronics Corporation, Tokyo (JP)

(21) Appl. No.: 15/216,755

(22) Filed: Jul. 22, 2016

(30) Foreign Application Priority Data
Aug. 25, 2015 (JP) 2015-165435

(51) Int. Cl. G09B 19/00

(52) U.S. Cl. CPC G09B 19/0038

(57) ABSTRACT

An object of the present invention is to provide a skill teaching verification system and a skill teaching verification program that can verify an effect of a teaching method for a skill.

An analyzing unit analyzes a plurality of pieces of sample data stored in a storing unit using a predetermined multivariate analyzing method. A motion template generation unit generates a standard human body motion model on the basis of an analysis result by the analyzing unit. A motion synthesizing unit generates a corrected human body motion model obtained by correcting the standard human body motion model on the basis of an instruction of a user. A verification unit predicts an attempt result obtained from the corrected human body motion model on the basis of the analysis result by the analyzing unit.

### CROSS-REFERENCE TO RELATED APPLICATIONS

The disclosure of Japanese Patent Application No. 2015-165435 filed on Aug. 25, 2015 including the specification, drawings and abstract is incorporated herein by reference in its entirety.

### BACKGROUND

The present invention relates to a skill teaching verification system and a skill teaching verification program, and relates to, for example, a technique used when trying a teaching method for various skills represented by sports.

For example, Japan Patent No. 5300426 discloses a guidance system for physical checkups. The technique provides a system in which data obtained by associating results of physical checkups of a plurality of patients with effective guidance given by a doctor is prepared and effective health guidance in the past is output when the result of physical checkups of a desired patient is input.

Further, “Motion synthesizer of pitching motion: utilization of statistical model aimed at disability prevention, written by Takeo Ishii, Journal of the Society of Biomechanisms, Vol. 39, No. 1, pp. 5-10, 2015” discloses an advice system targeting sports. In the system, attempt results of a plurality of (baseball) pitchers are obtained by motion capture in advance, and a motion as a main factor of the attempt results (ball speeds, control, lesions, and the like) is obtained by a principal component analysis. In addition, when a user inputs the motion data of the user obtained by the motion capture and a desired performance into the system, the system obtains an ideal motion for achieving the desired performance, and presents the same to the user.

### SUMMARY

For example, the technique disclosed in Japan Patent No. 5300426 is a technique in which one of effective guidance methods patterned with a certain degree is extracted from past achievements of a database. In the medical industry, in particular, a clinical trial is necessary when giving new medical guidance. Thus, the technique cannot be sufficiently utilized in some cases in a situation where a new guidance method with no past achievements is tried. On the other hand, there are many situations in which a new teaching method is tried in skill teaching, and a technique that can be utilized in the situations has been required.

Further, the technique disclosed in “Motion synthesizer of pitching motion: utilization of statistical model aimed at disability prevention, written by Takeo Ishii, Journal of the Society of Biomechanisms, Vol. 39, No. 1, pp. 5-10, 2015” is a technique useful when limited subjects with a clear goal (for example, increasing a ball speed) who can use the motion capture and the like receive teaching. However, in a situation where an instructor of the skill teaching tries a teaching method, there is a case that the technique cannot be sufficiently utilized. Further, a motion of a subject and a desired performance are input and an ideal motion is output in the technique. Therefore, there is a case that the user cannot clearly understand any points for improvement in the current motion even when viewing an ideal motion.

Embodiments to be described later have been achieved in view of the foregoing, and the other objects and novel features will become apparent from the description of the specification and accompanying drawings.

A skill teaching verification system according to an embodiment includes a storing unit, an analyzing unit, a motion template generation unit, a motion synthesizing unit, and a verification unit. The storing unit stores a plurality of pieces of sample data including a combination of data representing an actual human body motion in association with a predetermined skill and data of an attempt result obtained from the human body motion. The analyzing unit analyzes the pieces of sample data using a predetermined multivariate analyzing method. The motion template generation unit generates a standard human body motion model on the basis of an analysis result by the analyzing unit. The motion synthesizing unit generates a corrected human body motion model obtained by correcting the standard human body motion model on the basis of an instruction of a user. The verification unit predicts an attempt result obtained from the corrected human body motion model on the basis of the analysis result by the analyzing unit.

According to the embodiment, it is possible to provide a skill teaching verification system and a skill teaching verification program that can verify an effect of a teaching method for a skill.

### BRIEF DESCRIPTION OF THE DRAWINGS

FIG. 1 is an explanatory diagram for showing an example of an outline and a situation of use of a skill teaching verification system according to a first embodiment of the present invention;

FIG. 2 is a block diagram for showing a configuration example of the skill teaching verification system according to the first embodiment of the present invention;

FIG. 3 is an explanatory diagram for showing an example of outline processing content of an analyzing unit in FIG. 2;

FIG. 4 is a flowchart for showing an example of processing content of a verification unit in FIG. 2;

FIG. 5 is an outline view for showing an application example of the skill teaching verification system in FIG. 2;

FIG. 6 is a block diagram for showing a configuration example of a skill teaching verification system according to a second embodiment of the present invention;

FIG. 7 is an explanatory diagram for showing an example of outline processing content of a motion template generation unit in a skill teaching verification system according to a third embodiment of the present invention;

FIG. 8 is a flowchart for showing an example of detailed processing content of the motion template generation unit in FIG. 7;

FIG. 9 is a flowchart for showing an example of detailed processing content of a motion template generation unit in a skill teaching verification system according to a fourth embodiment of the present invention;

FIG. 10A is a block diagram for showing an outline configuration example around a verification unit in a skill teaching verification system according to a fifth embodiment of the present invention, and FIG. 10B is a flowchart for showing an example of processing content of a determination unit in FIG. 10A; and

FIG. 11 is a block diagram for showing a configuration example of a skill teaching verification system studied as a comparative example of the present invention.

### DETAILED DESCRIPTION

The present invention will be described using the following embodiments while being divided into a plurality of sections or embodiments if necessary for convenience sake. However, except for a case especially specified, the sections or embodiments are not irrelevant to each other, and one has a relationship as a part of a modified example or a complete modified example, or a detailed or supplementary explanation of the other. Further, if the specification refers to the number of elements (including the number of pieces, values, amounts, ranges, and the like) in the following embodiments, the present invention is not limited to the specific number, but may be smaller or larger than the specific number, except for a case especially specified or a case obviously limited to the specific number in principle.

Furthermore, it is obvious that the components (including elemental steps and the like) are not necessarily essential in the following embodiments, except for a case especially specified or a case obviously deemed to be essential in principle. Likewise, if the specification refers to the shapes or positional relationships of components in the following embodiments, the present invention includes those that are substantially close or similar to the components in shapes and the like, except for a case especially specified or a case obviously deemed not to be close or similar in principle. The same applies to the values and ranges.

Hereinafter, embodiments of the present invention will be described in detail on the basis of the drawings. It should be noted that the same members are given the same reference numerals in principle in the all drawings for explaining the embodiments, and the explanations thereof will be omitted.

### First Embodiment

### Outline and Place of Use of Skill Teaching Verification System

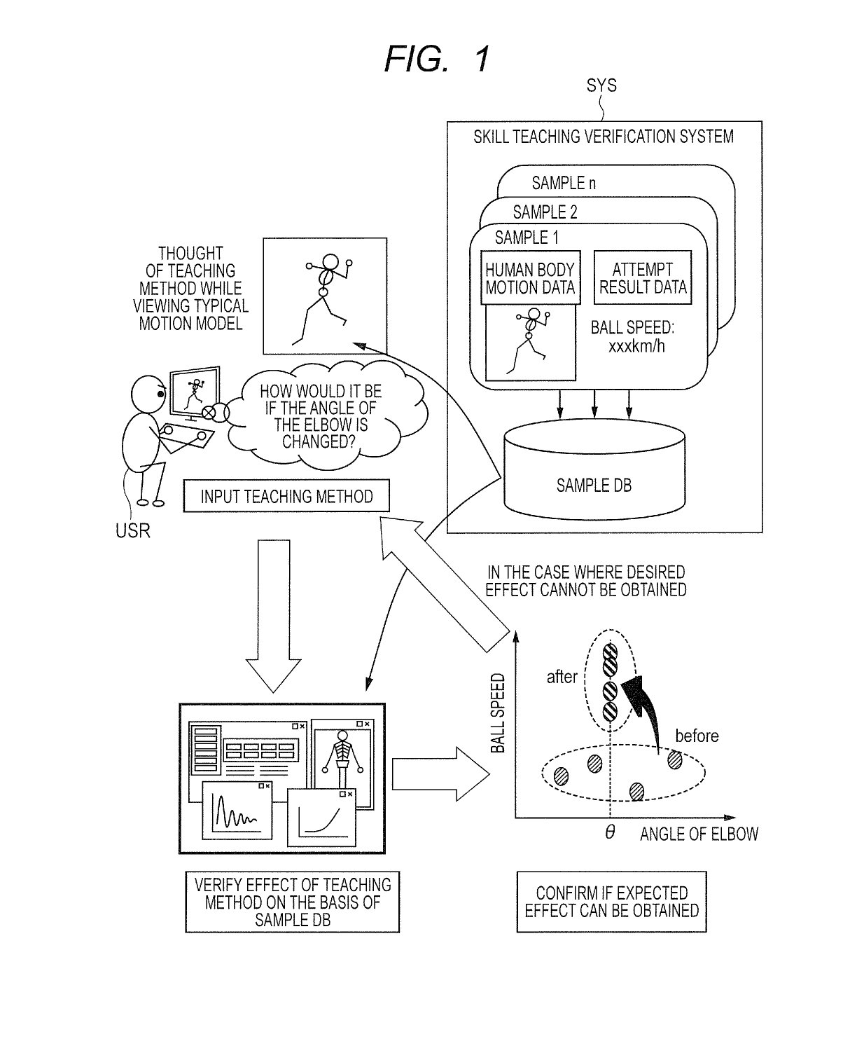

FIG. 1 is an explanatory diagram for showing an example of an outline and a situation of use of a skill teaching verification system according to a first embodiment of the present invention. In the example of FIG. 1, a skill teaching verification system SYS is used in a situation where skill teaching is conducted for a pitching motion of baseball. However, the skill teaching verification system is not particularly limited to the situation, but can be used in various situations, for example, a situation where skill teaching is conducted for various sports such as a running motion and a golf swing motion, or a situation where skill teaching is conducted for a play and choreography other than sports.

In FIG. 1, the skill teaching verification system SYS includes a sample database (hereinafter, abbreviated as sample DB). A plurality of pieces of sample data containing a combination of data representing an actual human body motion in association with a predetermined skill (a pitching motion in this case) and data (for example, ball speed data and the like) of an attempt result obtained from the human body motion is registered in the sample DB in advance. First, a user (for example, an instructor) USR thinks of a teaching method while viewing a typical motion model generated on the basis of the sample DB.

Next, the user USR inputs the teaching method the user thought of into the skill teaching verification system SYS. For example, the user USR inputs a teaching method such as changing the angle of the elbow at a certain point into the angle desired by the user. In response to this, the skill teaching verification system SYS verifies an effect obtained by the teaching method on the basis of the sample DB, and presents the same to the user USR. For example, in the case where a desired effect cannot be obtained, the user USR thinks of another teaching method. As described above, the skill teaching verification system SYS is a system that verifies an effect of a teaching method for a skill, and the user USR can seek an effective teaching method by using the skill teaching verification system SYS.

For example, as one of media through which many and unspecified users provide content, media called CGM (Consumer Generated Media) have been widely spread. In particular, many and unspecified users propose various teaching methods through such media, and it has been difficult from the past to objectively verify the benefit of each teaching method. Using the skill teaching verification system SYS of the first embodiment, for example, a mechanism of verifying the benefit of a teaching method can be provided to such many and unspecified users.

### Configuration and Operation of Skill Teaching Verification System

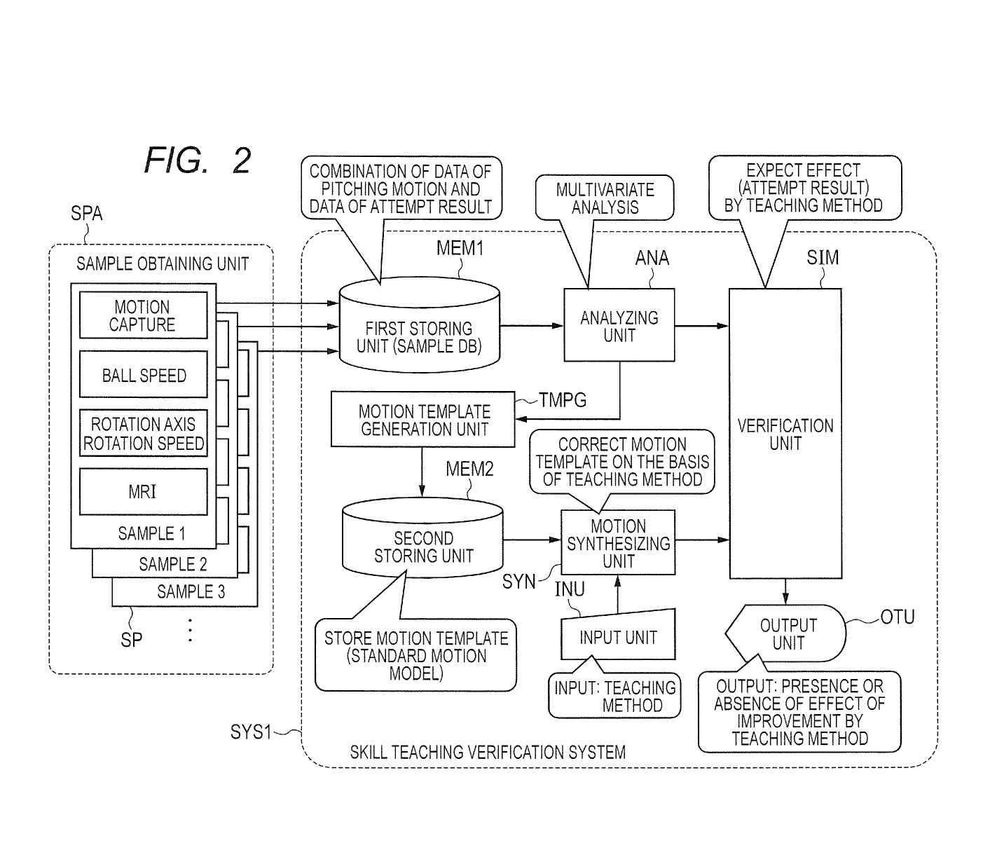

FIG. 2 is a block diagram for showing a configuration example of the skill teaching verification system according to the first embodiment of the present invention. A skill teaching verification system SYS1 shown in FIG. 2 includes a first storing unit MEM1, an analyzing unit ANA, a motion template generation unit TMPG, a second storing unit MEM2, a motion synthesizing unit SYN, a verification unit SIM, an input unit INU, and an output unit OTU. The first storing unit MEM1 corresponds to the sample DB shown in FIG. 1, and stores therein a plurality of pieces of sample data SP. Each sample data SP includes a combination of data representing an actual human body motion in association with a predetermined skill and data of an attempt result obtained from the human body motion.

The pieces of sample data SP are obtained by a sample obtaining unit SPA. The sample obtaining unit SPA obtains actual human body motion data in association with a predetermined skill (a pitching motion in this case) using existing various methods. As a concrete method of obtaining the human body motion data, there is, for example, a method using optical motion capture, or a method using a dynamic sensor using an infrared ray pattern or ToF (Time of Flight). Alternatively, a method in which an inertial sensor (an accelerating sensor or a gyro sensor) is attached to the body of a subject to obtain motion data may be used. Alternatively, data obtained by quantifying, using computer software or the like, motion trajectories of video data taken by a high-speed camera or a video camera may be used.

Further, the sample obtaining unit SPA obtains attempt result data that can be obtained from each human body motion data using existing various methods. The attempt result data is, for example, ball speed data, rotation speed data, lesion data, and the like. In addition, the attempt result data may be data such as a strikeout average or an opponents batting average. As a concrete method of obtaining the attempt result data, there is, for example, a method using a speed gun or a ball incorporating an inertial sensor (an accelerating sensor or a gyro sensor). Alternatively, the result may be extracted from moving images taken by a high-speed camera or a video camera. Alternatively, a user who attempted may manually input the attempt result. The lesion data may be obtained by a method using, for example, clinical data of a subject measured with medical equipment such as MRI (Magnetic Resonance Imaging) or diagnostic data containing opinions of a doctor.

The analyzing unit ANA analyzes the pieces of sample data stored in the first storing unit MEM1 using a predetermined multivariate analyzing method. As a representative multivariate analyzing method, there is a principal component analysis, a multiple regression analysis, a factor analysis, or a cluster analysis. As an example in the specification, an outline operation of the principal component analysis as shown in “Motion synthesizer of pitching motion: utilization of statistical model aimed at disability prevention, written by Takeo Ishii, Journal of the Society of Biomechanisms, Vol. 39, No. 1, pp. 5-10, 2015” will be described.

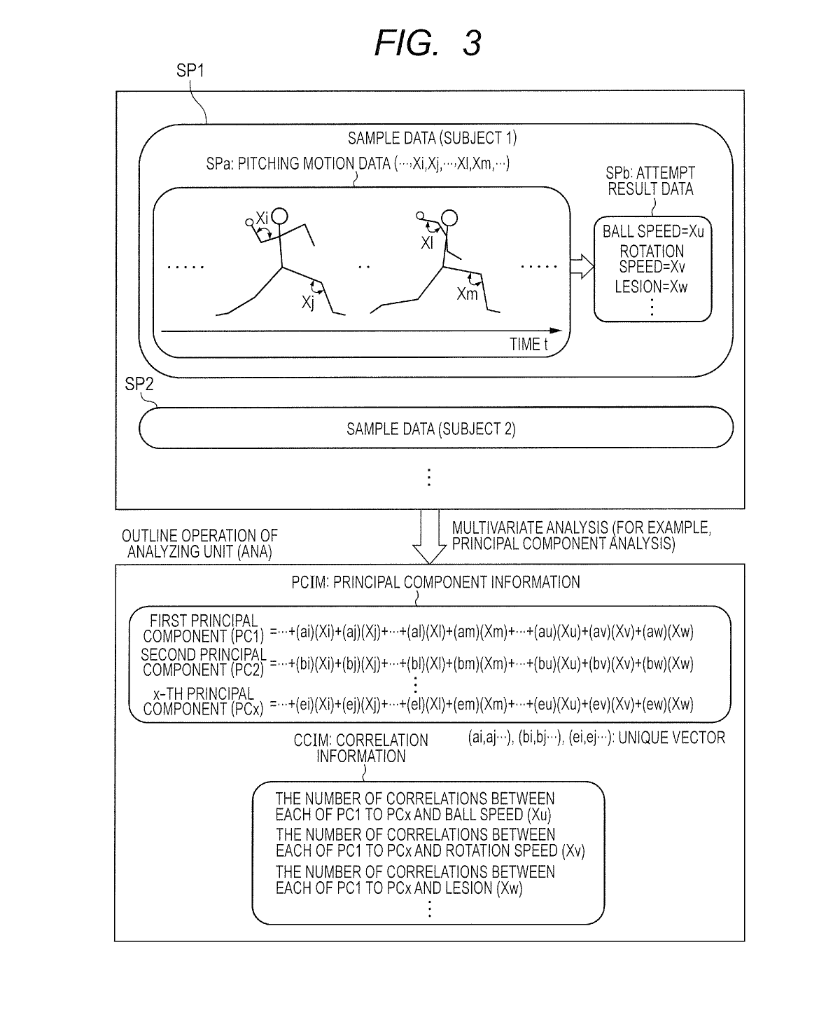

FIG. 3 is an explanatory diagram for showing an example of outline processing content of the analyzing unit in FIG. 2. Each of a plurality of pieces of sample data SP1, SP2, and the like contains the human body motion data and the attempt result data as described above, and each of the human body motion data and the attempt result data is configured using a plurality of parameters. Pitching motion data (human body motion data) Spa includes the parameters such as, for example, the angle Xi of a joint A, the angle Xj of a joint B, and the like at a certain time and the angle Xl of the joint A, the angle Xm of the joint B, and the like at another time.

As described above, the pitching motion data Spa is configured using, for example, thousands of parameters in accordance with the pitch width of time and the number of joints at each time. On the other hand, attempt result data SPb is configured using a few to tens of parameters such as, for example, a ball speed Xu, a rotation speed Xv, a lesion Xw, and the like. A series of pitching motion and the attempt result in association with the pitching motion are defined by one operating point on the real axis using the parameters configuring the pitching motion data Spa and the parameters configuring the attempt result data SPb.

The analyzing unit ANA conducts the principal component analysis for the pieces of sample data SP1, SP2, and the like containing such parameters, and calculates, for example, principal component information PCIM, correlation information CCIM, and the like. Specifically, the analyzing unit ANA calculates unique vectors (ai, aj, and the like) associating the parameters (Xi, Xj, and the like) of each sample data with a first principal component PC1 as the principal component information PCIM. Likewise, the analyzing unit ANA calculates unique vectors associating the parameters of each sample data with each of second to x-th principal components as the principal component information PCIM.

Further, the analyzing unit ANA calculates a correlation (specifically, a correlation coefficient) between each of first to x-th principal components PC1 to PCx and each parameter (a ball speed Xu, a rotation speed Xv, a lesion Xw, and the like) of the attempt result data SPb as the correlation information CCIM. Accordingly, the principal component highly correlated with each parameter of the attempt result data SPb can be clarified. It should be noted that the number of parameters of the sample data (in other words, the real axis) can reach thousands of pieces as described above. However, if the principal component analysis is conducted, the number (x) of parameters of the principal component (in other words, the principal component axis) can be compressed to, for example, tens of parameters in accordance with the contribution ratio.

In FIG. 2, the motion template generation unit TMPG generates a standard human body motion model (referred to as a motion template in the specification) on the basis of the analysis result by the analyzing unit ANA, and registers the same into the second storing unit MEM2. The motion template is generated by, for example, setting the parameter value (namely, principal component score) of each of the principal components PC1 to PCx to an average value. In this case, the motion template shows a motion obtained by averaging the motions of subjects registered in the sample DB, and a motion with which an average attempt result can be obtained.

The input unit INU provides an interface that allows a user to input a teaching method for the motion template. As a concrete input method, there is, for example, a method in which the motion of the motion template is displayed on a PC (Personal Computer), a smartphone, a tablet device, or the like using software such as 3D-CAD, and the user operates on the software (for example, the user changes the angle of the elbow in the example of FIG. 1). Alternatively, the user may attach an inertial sensor (an accelerating sensor or a gyro sensor) to the body of the user to input an actual motion. Alternatively, the user may input using the motion capture as similar to the case of the sample obtaining unit SPA.

The motion synthesizing unit SYN generates a corrected human body motion model obtained by correcting the motion template (standard human body motion model) on the basis of an instruction of the user input through the input unit INU. The verification unit SIM expects an attempt result to be obtained from the corrected human body motion model generated by the motion synthesizing unit SYN on the basis of the analysis result by the analyzing unit ANA. In addition, the verification unit SIM outputs the expected attempt result (namely, the presence or absence of the effect of improvement by the input teaching method) to the output unit OTU.

It should be noted that the output unit OUT in the skill teaching verification system SYS1 of FIG. 2 is configured using, for example, a display, a printer, or the like. The first storing unit MEM1 is configured using, for example, various types of non-volatile memories represented by a hard disk drive, a flash memory, and the like, and the second storing unit MEM2 is configured using various non-volatile memories or a volatile memory (RAM) or the like. The analyzing unit ANA, the motion template generation unit TMPG, the motion synthesizing unit SYN, and the verification unit SIM are configured by, for example, program processing using a computer including a CPU (Central Processing Unit) and the like.

Namely, the skill teaching verification system SYS1 of FIG. 2 can be mounted on, for example, one computer. In this case, when the CPU executes the skill teaching verification program stored in a RAM or a ROM, the computer functions as the analyzing unit ANA, the motion template generation unit TMPG, the motion synthesizing unit SYN, and the verification unit SIM. However, each unit is not necessarily limited to such a configuration, but, for example, some of the analyzing unit ANA, the motion template generation unit TMPG, the motion synthesizing unit SYN, and the verification unit SIM may be configured using dedicated hardware. Further, the respective units of the skill teaching verification system SYS1 in FIG. 2 may be appropriately dispersed and arranged in a plurality of computers coupled through a network.

### Operation of Verification Unit

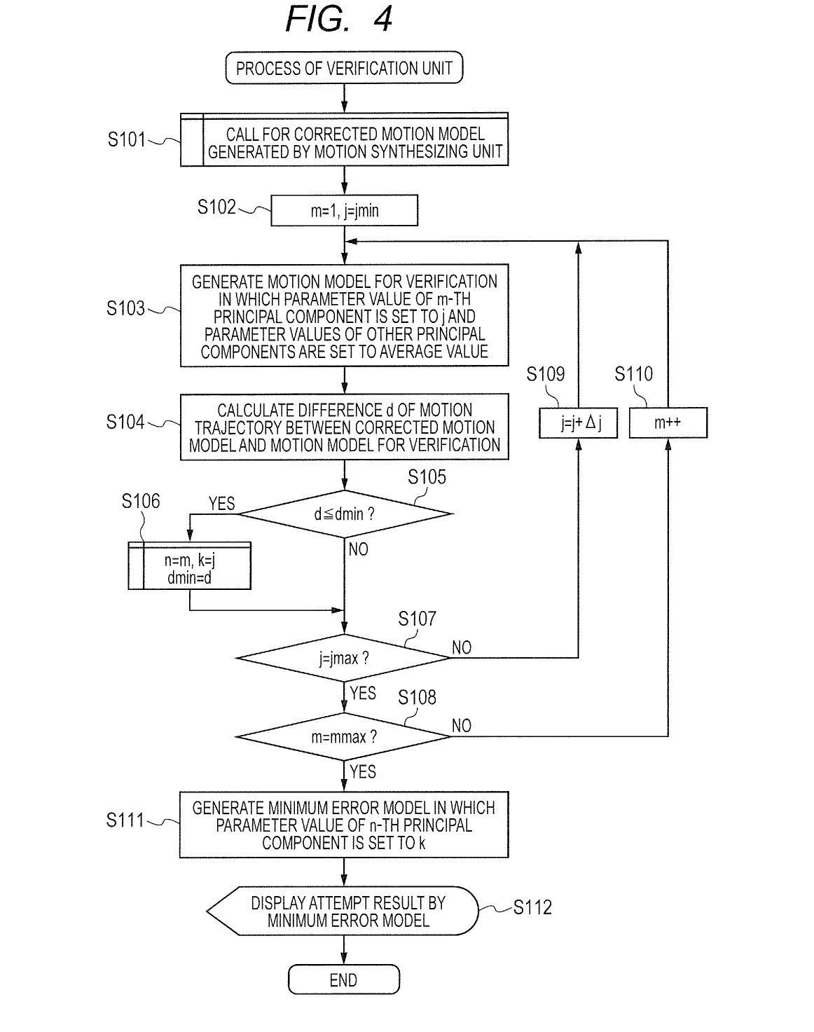

FIG. 4 is a flowchart for showing an example of processing content of the verification unit in FIG. 2. The human body motion model (referred to as a corrected motion model in the specification) generated and corrected by the above-described motion synthesizing unit SYN corresponds to, for example, a motion model in which the angle Xi of the joint A in the motion template is corrected in the example of FIG. 3. Namely, formed is a motion model in which the parameter values on the real axis in the motion template are operated.

However, there is such a case in a realistic motion of a human body that if the angle Xi of the joint A is corrected, the angle of another joint C is changed in conjunction with the correction of the joint A at the same time, and further the angles of the joints A and C are changed before and after the time. Accordingly, it is difficult in some cases to actually execute the motion obtained as a result of operating the parameter values on the rea axis.

On the other hand, each principal component can be regarded as a meaning of a series of motion patterns obtained by combining the angles of the joints in conjunction with each other to time-series changes, and the principal components can be regarded as a meaning of motion patterns having no correlation with each other. Accordingly, for example, in the case where the parameter values (namely, principal component scores) are moved on the principal component axis, the motion corresponding to the parameter values can be regarded as an actually-executable motion if the parameter values fall within a predetermined range. The predetermined range can be set as, for example, a range between the minimum value and the maximum value of the principal component scores. However, when the standard deviation of the principal component scores is σ, −2σ to +2σ or −1σ to +1σ is desirable in an actual case.

In view of the foregoing, the verification unit SIM performs the following outline processes. Namely, the verification unit SIM generates a human body motion model for verification (referred to as a motion model for verification in the specification) for each parameter value while changing the parameter values on the principal component axis, and searches for the motion model for verification whose motion trajectories are closest to the corrected motion model. Namely, the verification unit SIM searches for the motion model for verification on the principal component axis that is closest to the corrected motion model and can be possibly executed in an actual case. Each principal component axis is associated with the attempt result on the basis of the correlation information CCIM of FIG. 3. On the basis of this, the verification unit SIM sets the attempt result obtained from the motion model for verification that is a search result as an attempt result obtained from the corrected motion model, and presents the same to the user.

More specifically, as shown in FIG. 4, the verification unit SIM calls for the corrected motion model (Step S101), and generates the motion model for verification (Step S103). The motion model for verification is generated by setting the parameter value of the m-th principal component to j and setting the parameter values of the other principal components to an average value (for example, the principal component score=0). The verification unit SIM generates the motion model for verification (Step 5103) every time j is changed by Aj in the range of jmin to jmax and further m is changed by the number of principal components (1 to x in FIG. 3) (Step S102 and Step S107 to Step S110).

The verification unit SIM calculates a difference d of the motion trajectories between the corrected motion model and the motion model for verification every time the motion model for verification is generated (Step S104), and searches for the dimension (n) of the principal component having the smallest difference d and the parameter value (k) of the n-th principal component in the process (Steps S105 and S106). On the basis of the search result, the verification unit SIM generates a minimum error model in which the parameter value of the n-th principal component is set to k (Step S111), and displays the attempt result (specifically, for example, a difference from an average attempt result) by the minimum error model on the output unit OTU (Step S112).

It should be noted that the process of Step S104 is performed by, for example, an image analysis. Further, jmin and jmax are, as described above, the minimum value and the maximum value of the corresponding principal component scores, or −2σ and +2σ or −1σ and +1σ of the corresponding principal component scores, respectively. As Δj is smaller, the search accuracy is enhanced. On the other hand, as Δj is smaller, the processing load is increased. Thus, it is necessary to appropriately set Δj in consideration of the balance.

### Application Example of Skill Teaching Verification System

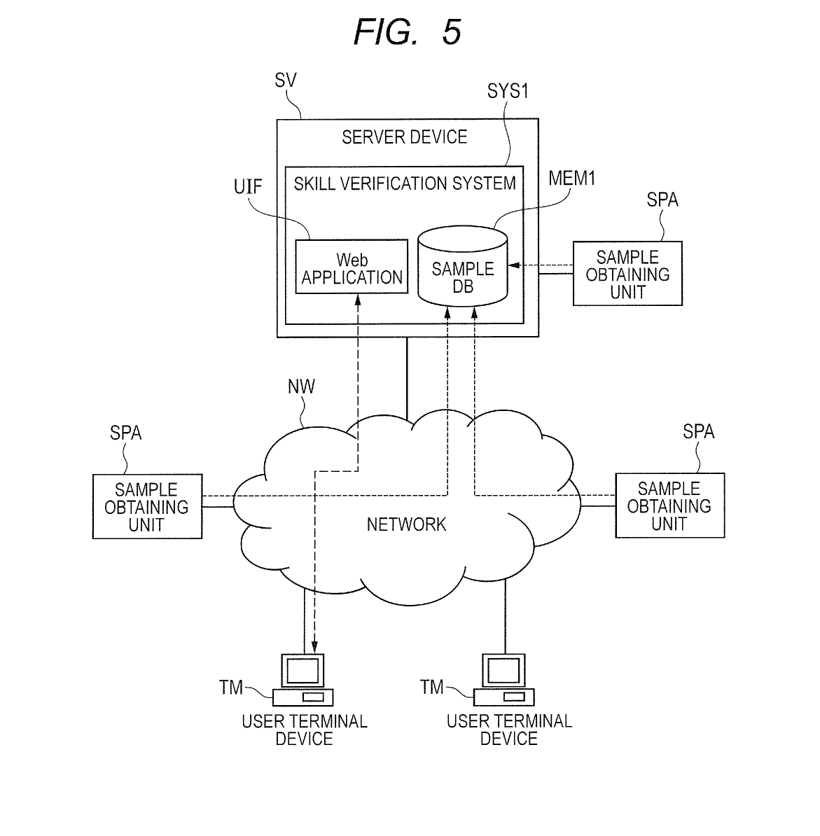

FIG. 5 is an outline view for showing an application example of the skill teaching verification system in FIG. 2. In the example of FIG. 5, a server device SV includes the skill teaching verification system SYS1 of FIG. 2. The skill teaching verification system SYS1 includes, for example, a user interface UIF for Web applications as the input unit INU and the output unit OUT of FIG. 2. Further, the server device SV is coupled to a plurality of sample obtaining units SPA directly or through a network NW, and is coupled to a plurality of user terminal devices TM through the network NW.

The sample data obtained by the sample obtaining units SPA is sequentially accumulated into the first storing unit (sample DB) MEM1 of the server device SV. The analyzing unit ANA of the skill teaching verification system SYS1 conducts the principal component analysis for the sequentially-accumulated sample data. On the other hand, many and unspecified users access the server device SV through the user terminal devices TM, and use the skill teaching verification system SYS1 through the user interface UIF of the server device SV.

### Major Effect of First Embodiment

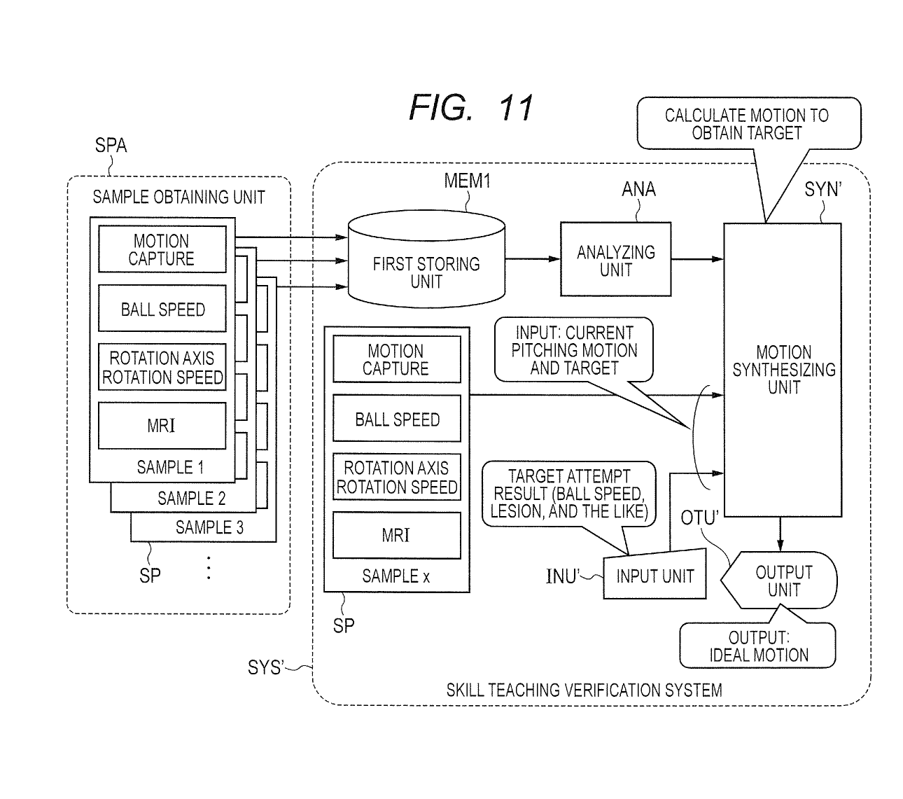

FIG. 11 is a block diagram for showing a configuration example of a skill teaching verification system studied as a comparative example of the present invention, and corresponds to the technique described in, for example, “Motion synthesizer of pitching motion: utilization of statistical model aimed at disability prevention, written by Takeo Ishii, Journal of the Society of Biomechanisms, Vol. 39, No. 1, pp. 5-10, 2015”. A skill teaching verification system SYS′ is mainly different from the configuration example of FIG. 2 in that the motion template generation unit TMPG and the verification unit SIM are not provided, and the processing content of a motion synthesizing unit SYN′ is different.

A user x of the skill teaching verification system SYS′ inputs a target attempt result through an input unit INU′ together with sample data (pitching motion data) SPx of the user. For example, the motion synthesizing unit SYN′ converts the input sample data SPx into parameter values on the principal component axis using unique vectors obtained by an analyzing unit ANA, moves the parameter values on the principal component axis on the basis of the target attempt result, and outputs the motion obtained as a result to an output unit OTU′ as an ideal motion.

However, in a situation where instructors (for example, many and unspecified users) of skill teaching try a teaching method, it is not easy to utilize such a skill teaching verification system SYS′ as described above. Specifically, it is difficult to verify the effect of the teaching method for the skill. Further, when the parameter values are moved on the principal component axis, many parameter values can be changed on the real axis. Therefore, there is a case that the user cannot clearly understand any points for improvement in the current motion even when viewing an ideal motion.

On the other hand, if the method of the first embodiment is used, it is possible to verify the effect of the teaching method for the skill. Accordingly, the instructors (many and unspecified users) of skill teaching can try an effective teaching method. In this case, the user inputs the parameter values not on the principal component axis but on the real axis.

Thus, for example, it is possible to verify the effect of the teaching method while paying attention to only a part of the body. Namely, it is possible to provide a user-friendly (in other words, improved convenience) system to the user.

### Second Embodiment

### Configuration and Operation of Skill Teaching Verification System (Applications)

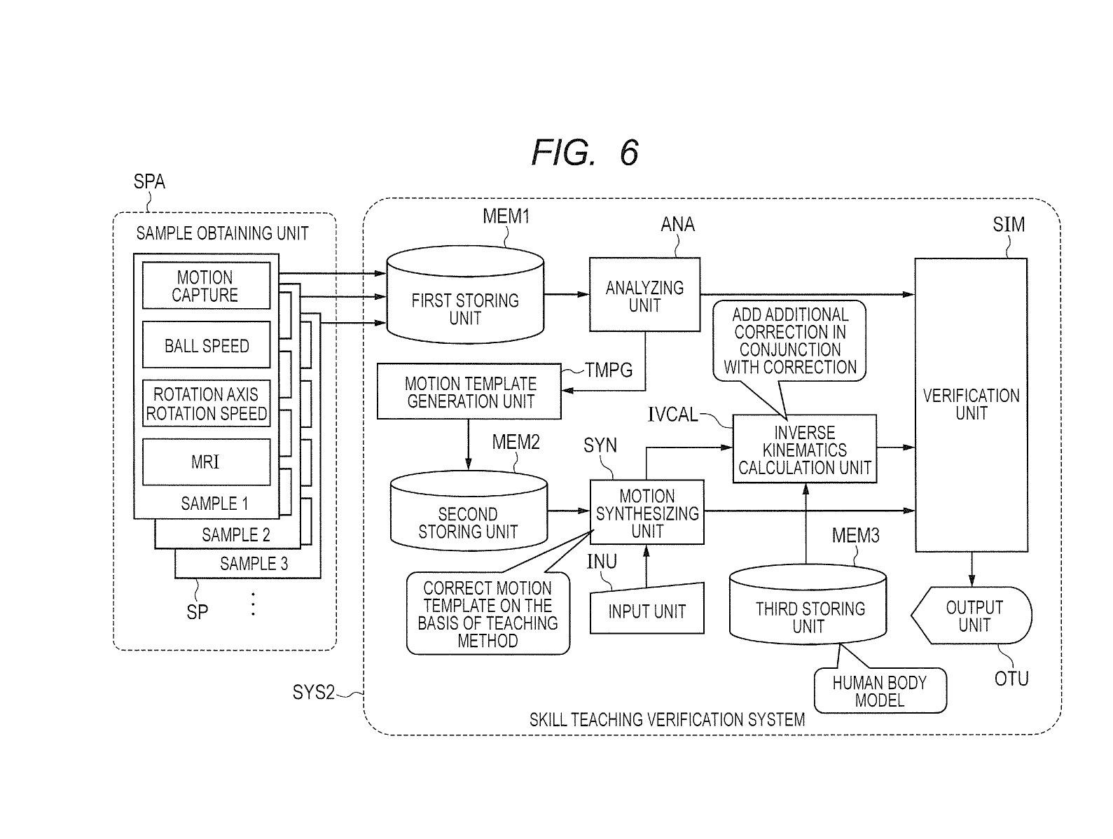

FIG. 6 is a block diagram for showing a configuration example of a skill teaching verification system according to a second embodiment of the present invention. A skill teaching verification system SYS2 shown in FIG. 6 is different from the configuration example of FIG. 2 in that an inverse kinematics calculation unit IVCAL and a third storing unit MEM3 are added. As described in the first embodiment, in the case where the motion of a specific site of a human body is corrected, a site different from the corrected site is generally changed in conjunction with the correction in many cases. The motions in conjunction with each other can be obtained by using an inverse kinematics calculation on the basis of so-called biomechanics.

Accordingly, human body model data on the basis of the inverse kinematics is stored in the third storing unit MEM3 in advance. To a correction on the basis of a teaching method (in other words, an instruction of a user) in a motion synthesizing unit SYN, the inverse kinematics calculation unit IVCAL further adds a correction in conjunction with the correction on the basis of the inverse kinematics to generate a corrected motion model. Here, in response to motion trajectories generated by the motion synthesizing unit SYN, the inverse kinematics calculation unit IVCAL further calculates motion trajectories other than a region corrected by the teaching method on the basis of the human body model data stored in the third storing unit MEM3. In response to the corrected motion model generated by the inverse kinematics calculation unit IVCAL, a verification unit SIM performs the process of FIG. 4 to verify the effect of improvement by the teaching method.

In addition to various effects described in the first embodiment, the effect of improvement by the teaching method can be further verified on the basis of the corrected motion model closer to an actual motion by using the skill teaching verification system of the second embodiment. Thus, the effect of improvement by the teaching method can be more accurately verified. Further, side effects and the like caused by the teaching method can be presented in some cases on the basis of a difference between the effect of improvement by the corrected motion model from the motion synthesizing unit SYN and the effect of improvement by the corrected motion model from the inverse kinematics calculation unit IVCAL.

### Third Embodiment

### Operation of Motion Template Generation Unit (Applications)

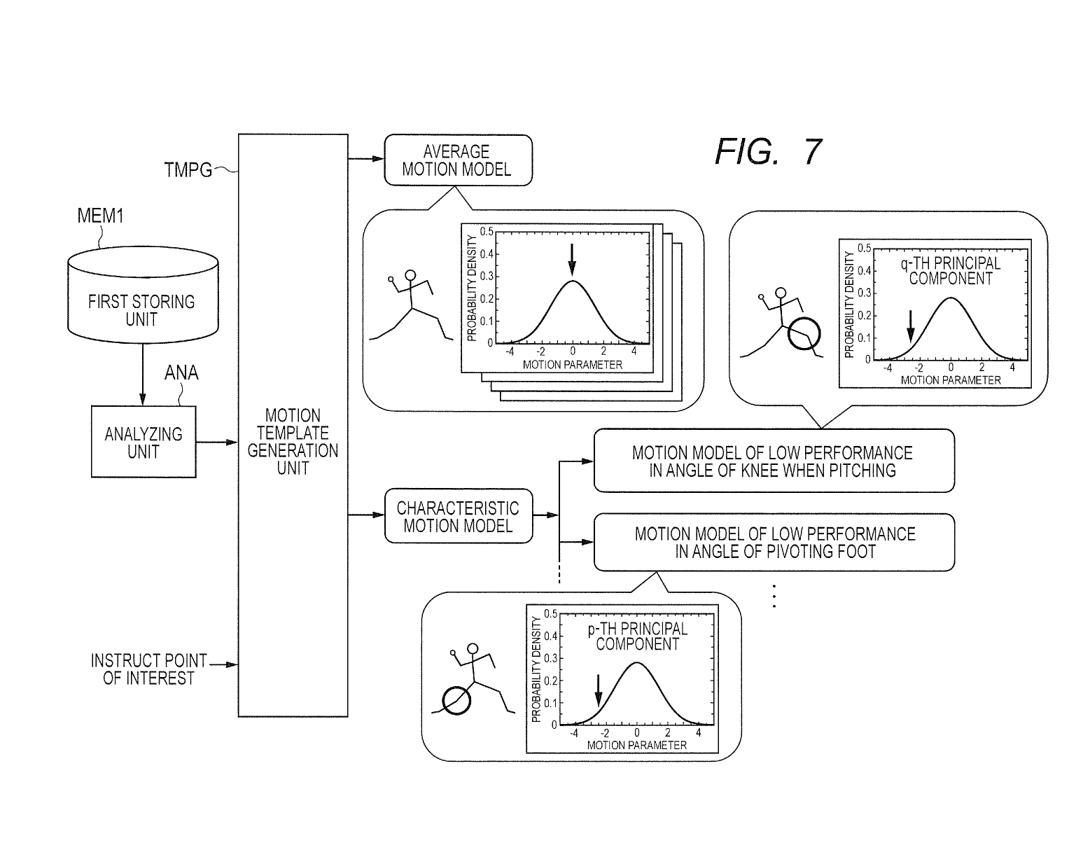

FIG. 7 is an explanatory diagram for showing an example of outline processing content of a motion template generation unit in a skill teaching verification system according to a third embodiment of the present invention. In the above-described first embodiment, the motion template generation unit TMPG generates a human body motion model (referred to as an average motion model in the specification) in which an average motion and an average attempt result can be obtained by setting the parameter value of the principal component to an average value as shown in FIG. 7.

However, for example, in the case where the skill level of each subject that is a base of the sample data is relatively high when the sample data is accumulated in the first storing unit MEM1, it is possibly difficult to visibly find an improvement in the motion of the average motion model. Namely, the skill teaching verification system according to the embodiment is a system that can be used by not only professional instructors, but also many and unspecified users. Accordingly, it is desirable in some cases to provide a motion template with which a teaching method can be easily tried from the viewpoints of many and unspecified users.

Accordingly, for example, the user designates a site on the human body motion of interest of the user in advance, so that the motion template generation unit TMPG generates, in addition to the average motion model, a characteristic human body motion model in which the site is characteristically moved as shown in FIG. 7. Specifically, the motion template generation unit TMPG generates, for example, a human body motion model in which the motion of the site of interest deteriorates the performance (namely, the worst attempt result).

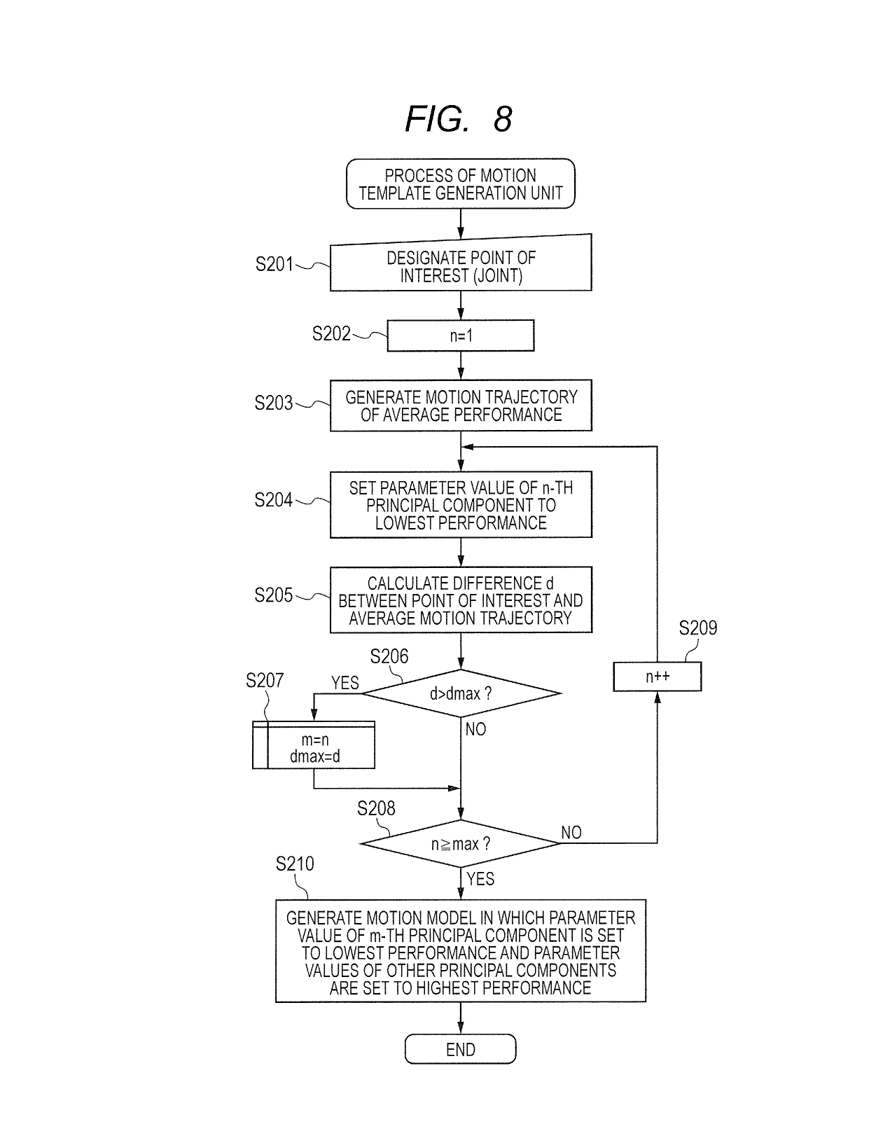

FIG. 8 is a flowchart for showing an example of detailed processing content of the motion template generation unit in FIG. 7. In FIG. 8, the user designates a site (for example, a joint) of interest (Step S201), and the motion template generation unit TMPG generates a motion template (namely, a standard characteristic human body motion model) focusing on the site. In this case, the motion template generation unit TMPG first generates the motion trajectories of the average motion model (Step S203).

Next, the motion template generation unit TMPG generates the motion trajectories in which the parameter value of the n-th principal component is set to the lowest performance (namely, the worst attempt result) in the average motion model (Step S204). Specifically, the motion template generation unit TMPG can determine, on the basis of the correlation information CCIM of FIG. 3, the direction (for example, the plus direction or minus direction) of the parameter value of the n-th principal component leading to the lowest performance, and sets a predetermined value in the direction. The predetermined value can be the maximum value or the minimum value of the parameter value (principal component score) of the n-th principal component, or ±2σ or ±1σ relative to the standard deviation of the n-th principal component.

Next, the motion template generation unit TMPG calculates a difference d related to the point of interest designated in Step S201 between the motion trajectories of the average motion model generated in Step S203 and the motion trajectories generated in Step S204 (Step S205). The difference d is calculated by, for example, an image analysis. The motion template generation unit TMPG performs the processes of Steps S204 and S205 every time the dimension (n) of the principal component is changed in the range of 1 to the maximum value (PC1 to PCx in the example of FIG. 3), and compares the differences d in the respective dimensions (n). Accordingly, the motion template generation unit TMPG searches for the dimension (m) of the principal component having the largest difference d (Step S202 and S206 to S209). As a result, it is possible to obtain a motion having the largest difference between the point of interest and the motion trajectories of the average motion model and possibly leading to the lowest performance.

In addition, the motion template generation unit TMPG generates a motion model (motion template) in which the parameter value of the m-th principal component as the search result is set to the values of the lowest performance, and the parameter values of the other principal components are set to the values of the highest performance (Step S210). Roughly speaking, the motion template generation unit TMPG searches for the principal component having the highest correlation with the point of interest (namely, the site on the human body motion on the basis of the instruction of the user), sets the parameter value of the principal component as the search result to the parameter value leading to the worst attempt result, and sets the parameter values of the other principal components to the parameter values leading to the best attempt result. Accordingly, the motion template generation unit TMPG generates the motion template.

The following effects in addition to various effects described in the first embodiment can be further obtained by using the skill teaching verification system of the third embodiment. First, a motion template with which a teaching method can be more easily tried or a motion template with which an effect by the teaching method of the user can be more easily obtained can be provided to the user. Further, it is possible to verify a teaching method using a standard motion model having various characteristics (in other words, assuming various people to be taught). As a result, the convenience of the user can be further improved.

### Fourth Embodiment

### Operation of Motion Template Generation Unit (Applications)

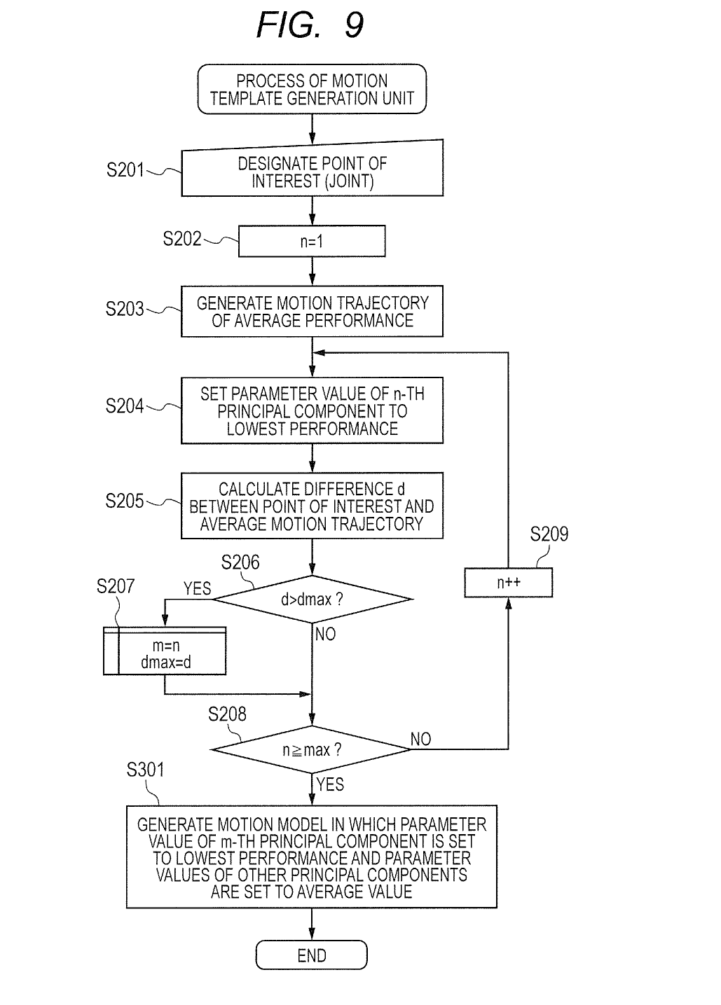

FIG. 9 is a flowchart for showing an example of detailed processing content of a motion template generation unit in a skill teaching verification system according to a fourth embodiment of the present invention. The flow shown in FIG. 9 is different from that shown in FIG. 8 in that the process of Step S210 of FIG. 8 is changed to the process of Step S301 of FIG. 9. As similar to Step S210, the motion template generation unit TMPG generates a motion model (motion template) in Step S301 in which the parameter value of the m-th principal component as the search result is set to the value of the lowest performance. However, Step S301 is different from Step S210 in that the motion template generation unit TMPG sets the parameter values of the other principal components of the motion model to be generated to not the highest performance but an average value.

For example, in the case where the parameter values of the other principal components are set to the highest performance as in Step S210, the following problem possibly arises. Namely, the levels of the “performance” for each principal component contradict each other depending on the type of performance in some cases. For example, in the case where a ball speed in the pitching motion and a lesion are set as the “performance”, when the parameter value of a principal component is the maximum value, the ball speed becomes the highest performance, but the lesion becomes the lowest performance in some cases.

In this case, it is necessary to allow the user to sequentially select whether the highest performance of a principal component is set on the basis of the ball speed (in this case, the parameter value becomes the maximum value) or the lesion (in this case, the parameter value becomes the minimum value). On the other hand, using the method of the fourth embodiment, various effects as described in the third embodiment can be obtained by setting the parameter values other than the point of interest to an average value without causing such a problem.

### Fifth Embodiment

### Configuration and Operation of Verification Unit (Applications)

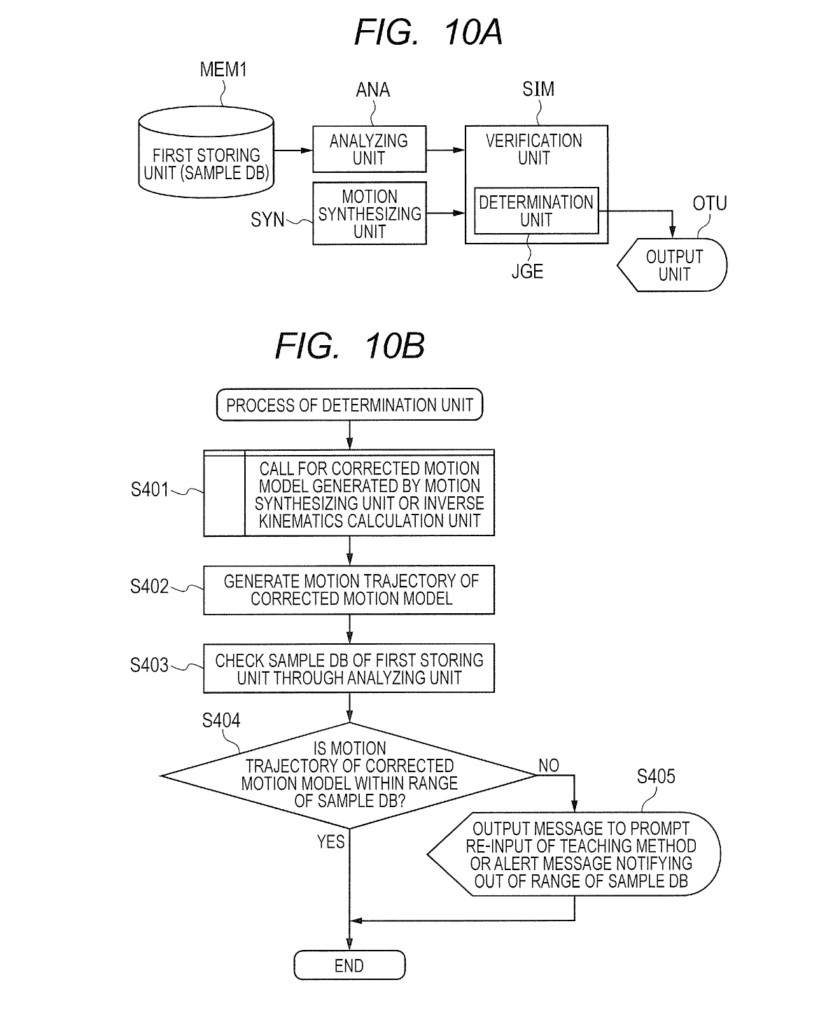

FIG. 10A is a block diagram for showing an outline configuration example around a verification unit in a skill teaching verification system according to a fifth embodiment of the present invention, and FIG. 10B is a flowchart for showing an example of processing content of a determination unit in FIG. 10A. A verification unit SIM shown in FIG. 10A performs the processes as shown in FIG. 4, and further includes a determination unit JGE. Roughly speaking, the determination unit JGE determines whether or not the corrected motion model input from the motion synthesizing unit SYN or the inverse kinematics calculation unit IVCAL of FIG. 6 exceeds the range of the human body motion supported by the pieces of sample data stored in the first storing unit MEM1.

Specifically, as shown in FIG. 10B, the determination unit JGE first calls for the corrected motion model generated by the motion synthesizing unit SYN or the inverse kinematics calculation unit IVCAL (Step S401), and generates the motion trajectories of the corrected motion model (Step S402). Next, the determination unit JGE checks the motion trajectories with the sample DB of the first storing unit MEM1 through the analyzing unit ANA (Step S403), and determines whether or not the motion trajectories of the corrected motion model fall within the range of the sample DB (Step S404).

There are various concrete determination methods. For example, the determination unit JGE converts the parameter value on the real axis corresponding to the corrected motion model to the parameter value of the principal component on the basis of the principal component information PCIM of FIG. 3, and determines whether or not the parameter value (principal component score) of each principal component falls within a predetermined range defined from the perspective of statistics. For example, there is a method in which the parameter values of the all principal components that fall within the range of ±1σ on the basis of the standard deviation σ of each principal component are regarded as within the range of the sample DB. Alternatively, there is another method in which the allowable range of the parameter values of a few principal components is extended to ±2σ, and is regarded as within the range of the sample DB.

When it is determined that the motion trajectories of the corrected motion model are out of range of the sample DB, the determination unit JGE outputs a message to prompt re-input of the teaching method or an alert message notifying out of range of the sample DB to the output unit OTU (Step S405). In response to this, for example, the user re-inputs the teaching method through the input unit INU.

For example, the skill teaching verification system shown in the first or second embodiment verifies the effect of improvement by the teaching method by generating the minimum error model in the process of FIG. 4 regardless of whether or not the corrected motion model falls within the range supported by the sample DB. However, in the case where the corrected motion model is out of range supported by the sample DB, the credibility of the effect of improvement is possibly dubious. Accordingly, in addition to various effects described in the first and second embodiments, the effect of improvement by the teaching method can be more accurately verified using the method of the fifth embodiment.

The invention achieved by the inventors has been described above in detail on the basis of the embodiments. However, the present invention is not limited to the above-described embodiments, but can be variously changed without departing from the scope of the invention. For example, the above-described embodiments have been described in detail to understandably explain the present invention, and are not necessarily limited to those having the all configurations described above. Further, a part of the configuration in one embodiment can be replaced by a configuration of another embodiment, and the configuration in one embodiment can be added to another embodiment. In addition, a part of the configuration in each embodiment can be added to or replaced by another, or deleted.

What is claimed is:

1. A skill teaching verification system comprising:
a storing unit that stores a plurality of pieces of sample data including a combination of data representing an actual human body motion in association with a predetermined skill and data of an attempt result obtained from the human body motion;
an analyzing unit that analyzes the pieces of sample data using a predetermined multivariate analyzing method;
a motion template generation unit that generates a standard human body motion model on the basis of an analysis result by the analyzing unit;
a motion synthesizing unit that generates a corrected human body motion model obtained by correcting the standard human body motion model on the basis of an instruction of a user, and
a verification unit that predicts an attempt result obtained from the corrected human body motion model on the basis of the analysis result by the analyzing unit.

2. The skill teaching verification system according to claim 1,
wherein the predetermined multivariate analyzing method is a principal component analysis, and
wherein the analyzing unit calculates a correlation between each principal component and the attempt result.

3. The skill teaching verification system according to claim 2,
wherein the verification unit generates a human body motion model for verification on a parameter value basis while changing a parameter value on a principal component axis, searches for the human body motion model for verification whose motion trajectories are closest to the corrected human body motion model, and defines an attempt result obtained from the human body motion model for verification that is the search result as an attempt result obtained from the corrected human body motion model.

4. The skill teaching verification system according to claim 2,
wherein the motion template generation unit generates the standard human body motion model by setting the parameter value of each principal component to an average value.

5. The skill teaching verification system according to claim 2,
wherein the motion template generation unit searches for a principal component having the highest correlation with a site on the human body motion on the basis of the instruction of the user, sets the parameter value of the principal component that is the search result to the parameter value leading to the worst attempt result, and generates the standard human body motion model by setting the parameter values of the other principal components to the parameter values leading to the best attempt result.

6. The skill teaching verification system according to claim 2,
wherein the motion template generation unit searches for a principal component having the highest correlation with a site on the human body motion on the basis of the instruction of the user, sets the parameter value of the principal component that is the search result to the parameter value leading to the worst attempt result, and generates the standard human body motion model by setting the parameter values of the other principal components to an average value.

7. The skill teaching verification system according to claim 1,
wherein an inverse kinematics calculation unit that generates the corrected human body motion model by further adding, to the correction on the basis of the instruction of the user in the motion synthesizing unit, a correction in conjunction with the correction on the basis of the inverse kinematics is further provided.

8. The skill teaching verification system according to claim 1,
wherein a determination unit that determines whether or not the corrected human body motion model exceeds the range of the human body motion supported by the pieces of sample data stored in the storing unit is further provided.

9. A skill teaching verification program allowing a computer to function as:
an analyzing unit that analyzes a plurality of pieces of sample data including a combination of data representing an actual human body motion in association with a predetermined skill and data of an attempt result obtained from the human body motion using a predetermined multivariate analyzing method;
a motion template generation unit that generates a standard human body motion model on the basis of an analysis result by the analyzing unit;
a motion synthesizing unit that generates a corrected human body motion model obtained by correcting the standard human body motion model on the basis of an instruction of a user, and
a verification unit that predicts an attempt result obtained from the corrected human body motion model on the basis of the analysis result by the analyzing unit.

10. The skill teaching verification program according to claim 9,
wherein the predetermined multivariate analyzing method is a principal component analysis, and
wherein the analyzing unit calculates a correlation between each principal component and the attempt result.

11. The skill teaching verification program according to claim 10,
wherein the verification unit generates a human body motion model for verification on a parameter value basis while changing a parameter value on a principal component axis, searches for the human body motion model for verification whose motion trajectories are closest to the corrected human body motion model, and defines an attempt result obtained from the human body motion model for verification that is the search result as an attempt result obtained from the corrected human body motion model.

12. The skill teaching verification program according to claim 10,
wherein the motion template generation unit generates the standard human body motion model by setting the parameter value of each principal component to an average value.

13. The skill teaching verification program according to claim 10, wherein the motion template generation unit searches for a principal component having the highest correlation with a site on the human body motion on the basis of the instruction of the user, sets the parameter value of the principal component that is the search result to the parameter value leading to the worst attempt result, and generates the standard human body motion model by setting the parameter values of the other principal components to the parameter values leading to the best attempt result.

14. The skill teaching verification program according to claim 10,
wherein the motion template generation unit searches for a principal component having the highest correlation with a site on the human body motion on the basis of the instruction of the user, sets the parameter value of the principal component that is the search result to the parameter value leading to the worst attempt result, and generates the standard human body motion model by setting the parameter values of the other principal components to an average value.

15. The skill teaching verification program according to claim 9, allowing the computer to further function as an inverse kinematics calculation unit that generates the corrected human body motion model by further adding, to the correction on the basis of the instruction of the user in the motion synthesizing unit, a correction in conjunction with the correction on the basis of the inverse kinematics.

16. The skill teaching verification program according to claim 9, allowing the computer to further function as a determination unit that determines whether or not the corrected human body motion model exceeds the range of the human body motion supported by the pieces of sample data.
